(19) United States
(12) Patent Application Publication
(10) Pub. No.: US 2016/0025505 A1
(43) Pub. Date: Jan. 28, 2016

(54) APPARATUS AND METHOD FOR GENERATING GLOBAL PATH FOR AN AUTONOMOUS VEHICLE

(71) Applicant: HYUNDAI MOTOR COMPANY, Seoul (KR)

(72) Inventors: Young Chul OH, Seongnam-si (KR); Myung Seon HEO, Seoul (KR); Byung Yong YOU, Suwon-si (KR)

(21) Appl. No.: 14/562,405

(22) Filed: Dec. 5, 2014

(30) Foreign Application Priority Data
Jul. 28, 2014 (KR) 10-2014-0095874

(51) Int. Cl. G01C 21/34

(52) U.S. Cl. CPC G01C 21/34

(57) ABSTRACT

There are provided an apparatus and method for generating a global path for an autonomous vehicle. The apparatus for generating a global path for an autonomous vehicle includes a sensor module including one or more sensors installed in the vehicle, a traffic information receiver configured to receive traffic information through wireless communication, a path generator configured to generate one or more candidate paths based on the traffic information, a difficulty evaluator configured to evaluate a difficulty of driving in the one or more candidate paths in each section of the one or more candidate paths using recognition rates of the one or more sensors and the traffic information, and an autonomous driving path selector configured to finally select an autonomous driving path by evaluating the one or more candidate paths based on the evaluation of the difficulty of driving.

### CROSS-REFERENCE TO RELATED APPLICATION

This application is based on and claims the benefit of priority to Korean Patent Application No. 10-2014-0095874, filed on Jul. 28, 2014 in the Korean Intellectual Property Office, the disclosure of which is incorporated herein in its entirety by reference.

### TECHNICAL FIELD

The present disclosure relates to an apparatus and method for generating a global path for an autonomous vehicle and, more particularly, to an apparatus and method for generating a global path for an autonomous vehicle in consideration of sensor recognition rates and a difficulty of driving in the generated global path for autonomous driving.

### BACKGROUND

In general, autonomous vehicles refer to vehicles that determine a path from a current location to a target location by themselves without a user manipulation and move along the determined path. Autonomous vehicles generate a path to drive by measuring waypoints of the path through a global positioning system (GPS), and drive along the generated global path. Here, the path is generated with patterns of an optimal path, a free road, a minimum time, a novice path, expressway precedence, the shortest distance, regular road precedence, reflection of real-time traffic information, and the like.

Conventional autonomous vehicles may have difficulty in driving if they select topography that significantly affects a sensor installed in the vehicles as a path or if they select a path with a very high difficulty of driving.

### SUMMARY

The present disclosure has been made to solve the above-mentioned problems occurring in the prior art while advantages achieved by the prior art are maintained intact.

An aspect of the present disclosure provides an apparatus and method for generating a global path for an autonomous vehicle in consideration of a sensor recognition rate and a difficulty of driving in the generated global path for autonomous driving.

According to an exemplary embodiment of the present disclosure, an apparatus for generating a global path for an autonomous vehicle includes: a sensor module including one or more sensors installed in a vehicle, a traffic information receiver configured to receive traffic information through wireless communication, a path generator configured to generate one or more candidate paths based on the traffic information, a difficulty evaluator configured to evaluate a difficulty of driving in the one or more candidate paths in each section using recognition rates of the one or more sensors and the traffic information, and an autonomous driving path selector configured to finally select an autonomous driving path by evaluating the one or more candidate paths in consideration of the evaluation of the difficulty of driving.

The sensor module may include one or more of an image sensor, a camera, a global positioning system (GPS), a laser scanner, a radar, a lidar, an inertial measurement unit (IMU), and an initial navigation system (INS).

The traffic information may include a road traffic state, accident information, road control information, weather information, and autonomous driving failure probability information.

The difficulty evaluator may recognize the one or more sensors installed in the vehicle, and evaluate a difficulty of driving in each of the candidate paths in each section according to driving environment recognition rates of the one or more recognized sensors.

The difficulty evaluator may determine a difficulty of driving in each of the candidate paths in each section based on the one or more sensors installed in the vehicle, traffic congestion, weather information of each section, and autonomous driving failure probability information of each section.

The path generator may generate the one or more candidate paths based on a time or a distance.

According to another exemplary embodiment of the present disclosure, a method for generating a global path for an autonomous vehicle includes: receiving a destination when an autonomous driving mode is executed, generating one or more candidate paths between a starting point of a vehicle and the destination, evaluating a difficulty of driving in the one or more candidate paths in each section in consideration of driving environment recognition rates of the one or more sensors installed in the vehicle, and selecting any one of the one or more candidate paths, as an autonomous driving path, based on the results of the difficulty of driving in each section.

In the generating of the one or more candidate paths, the one or more candidate paths may be generated based on a time or a distance.

In the evaluating of the difficulty of driving of one or more candidate paths in each section, a difficulty of driving may be evaluated based on driving environment recognition rates of the one or more sensors, traffic congestion, weather information, and autonomous driving failure probability information.

The driving environment recognition rates of the one or more sensors indicate a reliability of a lane recognition, a vehicle and structure recognition, and location recognition by the one or more sensors.

### BRIEF DESCRIPTION OF THE DRAWINGS

The above and other objects, features and advantages of the present disclosure will be more apparent from the following detailed description taken in conjunction with the accompanying drawings.

FIG. 1 is a block diagram illustrating an apparatus for generating a global path for an autonomous vehicle according to an exemplary embodiment of the present disclosure.

FIG. 2 is a flow chart of a method for generating a global path for an autonomous vehicle according to an exemplary embodiment of the present disclosure.

FIG. 3 is illustrates an exemplary evaluation of a difficulty of driving according to recognition rates of sensors according to an exemplary embodiment of the present disclosure.

### DETAILED DESCRIPTION

Hereinafter, exemplary embodiments of the present disclosure will be described in detail with reference to the accompanying drawings.

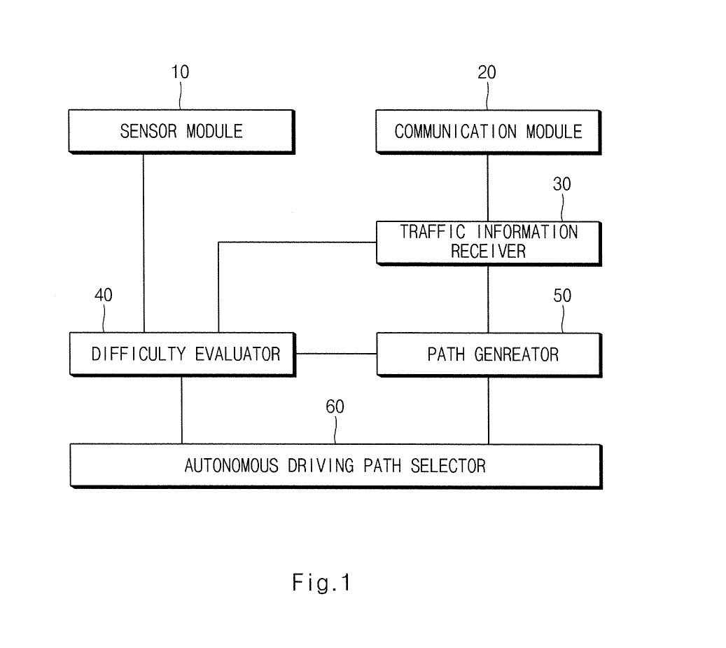

FIG. 1 is a block diagram illustrating an apparatus for generating a global path for an autonomous vehicle according to an exemplary embodiment of the present disclosure.

Referring to FIG. 1, an apparatus for generating a global path for an autonomous vehicle includes a sensor module 10, a communication module 20, a traffic information receiver 30, a difficulty evaluator 40, a path generator 50, and an autonomous driving path selector 60.

The sensor module 10 is installed in a vehicle and includes various sensors (not shown). In one exemplary embodiment of the present disclosure, the sensor module 10 includes an image sensor, a camera, a global positioning system (GPS), a laser scanner, a radar, a lidar, an inertial measurement unit (EMU), an inertial navigation system (INS), and the like.

The communication module 20 serves to perform wireless communication with an external system (e.g., a traffic information center) or terminals.

The traffic information receiver 30 is configured to receive traffic information provided from a traffic information center through the communication module 20 in real time. Here, the traffic information includes a road traffic status (traffic congestion status), accident information, road control information, weather information, autonomous driving failure probability information, nation, and the like.

The difficulty evaluator 40 evaluates difficulty of driving based on recognition rates (driving environment recognition rates) of the sensors constituting the sensor module 10 and traffic information. The difficulty evaluator 40 is linked to sensors installed in the vehicle and evaluates difficulty of driving (difficulty of driving control) of each section of the path based on recognition capability of the sensors (reliability of results of recognizing a driving environment by the sensors).

In case of an intersection without a lane, the difficulty evaluator 40 determines a difficulty of driving according to a detailed map and accuracy of an inertial measurement unit. Namely, when a vehicle has a detailed map and an inertial measurement unit with high accuracy, the difficulty evaluator 40 determines that a difficulty of driving is low, and when a vehicle has a detailed map and an inertial measurement unit with low accuracy, the difficulty evaluator 40 determines that a difficulty of driving is high.

Also, in a case in which a vehicle is equipped with only a GPS, when a section in which the vehicle passes through high-rise buildings exists in a driving path, the difficulty evaluator 40 determines that a difficulty of driving is the highest, and excludes the corresponding section from the driving path. Meanwhile, in a case in which a vehicle has a simultaneous localization and map-building or simultaneous localization and mapping (SLAM) based on a 3D lidar sensor, the difficulty evaluator 40 determines a difficulty of driving of a driving-available path according to accuracy of the SLAM. For example, the difficulty evaluator 40 determines that a difficulty of driving is low as accuracy of the SLAM is high.

The difficulty evaluator 40 is configured to measure a lane recognition reliability (sensor recognition rate) of an image sensor (camera) using a difference in brightness between a lane and a peripheral road. Namely, when the reliability is high, the difficulty evaluator 40 determines that a difficulty is low, and when reliability is low, the difficulty evaluator 40 determines that a difficulty is high.

The difficulty evaluator 40 determines a difficulty of driving according to a vehicle based on a distance sensor and lane recognition reliability through recognition of a structure. For example, in case of a road with a metal guard rail, when sensors installed in a vehicle are a radar and a lidar, since both the sensors are able to recognize a guard rail, they are utilized as lane recognition data, thereby reducing a difficulty of driving.

Meanwhile, in case of a guardrail fowled of stone, when a sensor attached in a vehicle is a lidar, since the sensor is not able to recognize the guardrail, the sensor cannot be utilized as lane recognition data, thereby increasing a difficulty of driving.

The difficulty evaluator 40 determines traffic congestion based on a vehicle speed and real-time traffic information, and when a vehicle needs to be slowed down or when a lane needs to be changed in a congested section, the difficulty evaluator 40 determines that a difficulty of driving is high, and when there is no need to change a lane, the difficulty evaluator 40 determines that a difficulty of driving is low.

The difficulty evaluator 40 may evaluate a difficulty of driving using map information stored in a memory (not shown). For example, as a distance from an interchange that a vehicle has entered to a coming point where a lane needs to be changed is shorter, the difficulty evaluator 40 increases the difficulty of driving. Namely, as driving stability is lowered in autonomous driving, the difficulty evaluator 40 increases the difficulty of driving.

The difficulty evaluator 40 evaluates a difficulty of driving in consideration of autonomous driving failure probability information of each section. In the event of an autonomous driving mode failure of a vehicle, a traffic information center collects information related to the autonomous driving failure such as a location, a node number, a failure cause (recognition/control), and the like, analyzes the collected information to calculate and manage autonomous driving failure probability information, and provides the same to a vehicle.

Autonomous systems provided in most vehicles have a similar recognition method and control performance. Thus, if a vehicle fails in a driving environment recognition and/or driving control, other vehicles are also likely to fail. Thus, by increasing a difficulty of driving with respect to a section with a high autonomous driving failure probability, the corresponding section may be avoided when an autonomous driving path is generated.

When destination information is input in setting an autonomous driving mode, the path generator 50 generates (extracts) candidate paths between a starting point (e.g., a current location) and a destination based on traffic information. In this case, the path generator 50 also generates the candidate paths based on a time and/or a distance, for example.

The destination information may be directly input by a user (e.g., a driver) or pre-set destination information may be received from a navigation terminal.

The autonomous driving path selector 60 selects any one of one or more candidate paths output from the path generator 50 as an autonomous driving path based on the sensor recognition rate and the difficulty of driving.

The autonomous driving path selector 60 may exclude a path including a section with a high difficulty of driving causing autonomous driving failure from the candidate paths. For example, the autonomous driving path selector 60 may exclude a path including a section in which it is difficult to recognize a traffic light and a lane on a rainy day, from the candidate paths.

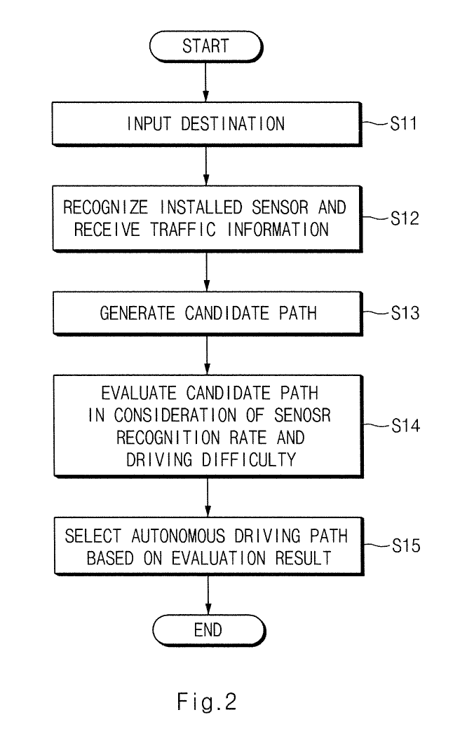

FIG. 2 is a flow chart of a method for generating a global path for an autonomous vehicle according to an exemplary embodiment of the present disclosure.

First, an apparatus for generating a global path for an autonomous vehicle receives destination information when an autonomous driving mode is executed, at Step S11. In this case, the destination information may be directly input by a user (e.g., a driver) or pre-set destination information may be provided from a navigation terminal.

The apparatus for generating a global path for an autonomous vehicle receives traffic information through the communication module 20 and is linked to sensors installed in a vehicle, at Step S12. Here, the traffic information includes a road traffic status (traffic congestion status), accident information, road control information, weather information, autonomous driving failure probability information, and the like. In a vehicle, one or more of an image sensor, a camera, a global positioning system (GPS), a laser scanner, a radar, a lidar, an inertial measurement unit (IMU), an initial navigation system (INS), and the like, are installed.

The path generator 50 of the autonomous vehicle generates one or more candidate paths using the traffic information received through the traffic information receiver 30, at Step S13. In this case, the path generator 50 selects a candidate path using a driving path generation algorithm. For example, the path generator 50 selects a candidate path based on a distance and/or time.

The difficulty evaluator 40 of the autonomous vehicle measures a driving environment recognition rate through the sensors installed in the vehicle and evaluates the candidate paths based on the measured sensor recognition rates and traffic information, at Step S14.

The autonomous driving path selector 60 of the autonomous vehicle selects any one of the candidate paths, as an autonomous driving path, according to the evaluation results, at Step S15.

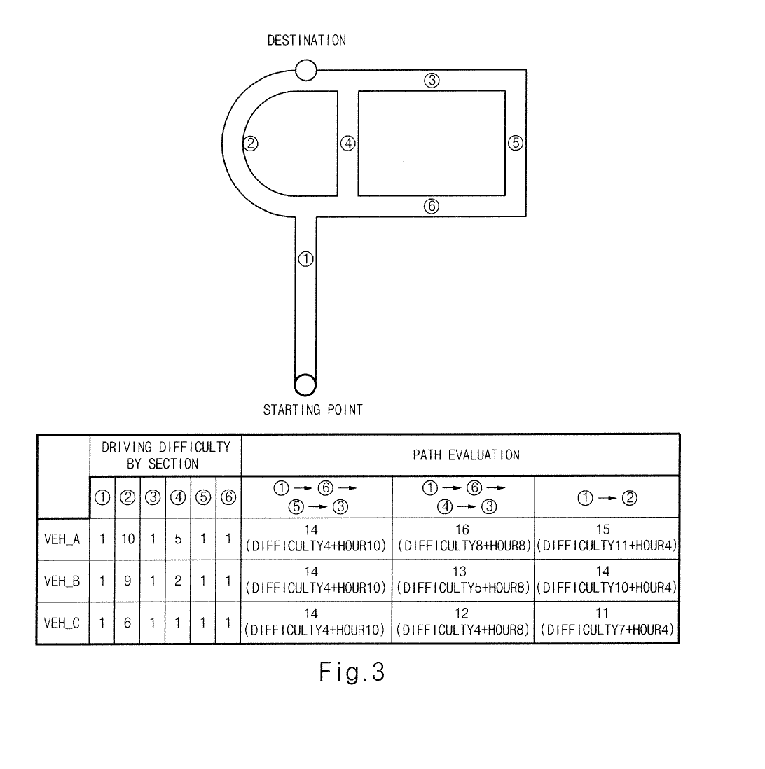

FIG. 3 is illustrates an exemplary evaluation of a difficulty of driving according to recognition rates of sensors according to an exemplary embodiment of the present disclosure.

Referring to FIG. 3, when destination information is received, the path generator 50 generates candidate paths between a starting point and the destination as follows and calculates an estimated required time of each of the generated candidate paths.

First candidate path: \textcircled{1}→\textcircled{6}→\textcircled{5}→\textcircled{3} (10 hours is required)

Second candidate path: \textcircled{1}→\textcircled{6}→\textcircled{4}→\textcircled{3} (8 hours is required)

Third candidate path: \textcircled{1}→\textcircled{2} (4 hours is required)

Driving environments of sections of the candidate paths are as shown in Table I.

TABLE 1

| Section | Characteristics of driving environment |
|---|---|
| \textcircled{2} | Marked state of lane is defective |
| | Peripheral high-rise building |
| \textcircled{4} | Structure estimated to be lane (guardrail) exists |
| | Marked state of lane is defective |
| | Peripheral high-rise building |
| \textcircled{1}, \textcircled{3}, \textcircled{5}, | Lane state is good |
| \textcircled{6} | Peripheral low building |

An evaluation table for selecting optimal global paths appropriate for autonomous driving of vehicles is shown in FIG. 3. Here, it is assumed that vehicle A (VEH_{—A}) includes a camera, a radar, a low-priced GPS and an IMU, vehicle B (VEH_{—B}) includes a camera, a lidar, a low-priced GPS, and an IMU, and vehicle C (VEH_{—C}) includes a camera, a lidar, a high-priced GPS, and an IMU. A case in which a weight value 1 is given to each of time and difficulty to evaluate each path will be described as an example.

The autonomous driving path selector 60 finally selects a path having the lowest evaluation scores with respect to each path, as an autonomous driving path. Referring to the table of FIG. 3, vehicle A selects a first candidate path as an autonomous driving path, vehicle B selects a second candidate path as an autonomous driving path, and vehicle C selects a third candidate path as an autonomous driving path.

Difficulty in each section is a difficulty of driving based on reliability regarding lane recognition, vehicle and structure recognition, and location recognition by each sensor.

As described above, according to the exemplary embodiments of the present disclosure, in case of generating a global path for autonomous driving, a global path is generated in consideration of a sensor recognition rate and a difficulty of driving, as well as a time and a distance. Thus, a global path in which stability of an autonomous vehicle is secured can be obtained.

Also, a path, which does not have a difficulty that a beginning driver cannot control, can be obtained.

The present disclosure described above may be variously substituted, altered, and modified by those skilled in the art to which the present disclosure pertains without departing from the scope and spirit of the present disclosure. Therefore, the present disclosure is not limited to the above-mentioned exemplary embodiments and the accompanying drawings.

What is claimed is:

1. An apparatus for generating a global path for an autonomous vehicle, the apparatus comprising:
a sensor module including one or more sensors installed in the vehicle;
a traffic information receiver configured to receive traffic information through wireless communication;
a path generator configured to generate one or more candidate paths based on the traffic information;
a difficulty evaluator configured to evaluate a difficulty of driving of the one or more candidate paths in each section of the one or more candidate paths using recognition rates provided by the one or more sensors and the traffic information; and
an autonomous driving path selector configured to finally select an autonomous driving path by evaluating the one or more candidate paths based on the evaluation of the difficulty of driving.

2. The apparatus according to claim 1, wherein the sensor module includes one or more of an image sensor, a camera, a global positioning system (GPS), a laser scanner, a radar, a lidar, an inertial measurement unit (IMU), and an inertial navigation system (INS).

3. The apparatus according to claim 1, wherein the traffic information includes a road traffic state, accident information, road control information, weather information, and autonomous driving failure probability information.

4. The apparatus according to claim 1, wherein the difficulty evaluator is linked to the one or more sensors installed in the vehicle, and evaluates a difficulty of driving of each of the candidate paths in each section according to driving environment recognition rates of the one or more recognized sensors.

5. The apparatus according to claim 1, wherein the difficulty evaluator determines the difficulty of driving of each of the candidate paths in each section of the one or more candidate paths based on the one or more sensors installed in the vehicle, traffic congestion, weather information of each section, and autonomous driving failure probability information of each section.

6. The apparatus according to claim 1, wherein the path generator generates the one or more candidate paths based on a time and a distance.

7. A method for generating a global path for an autonomous vehicle, the method comprising:
receiving a destination when an autonomous driving mode is executed;
generating one or more candidate paths between a starting point of a vehicle and the destination;
evaluating a difficulty of driving of the one or more candidate paths in each section of the one or more candidate paths in consideration of driving environment recognition rates provided by one or more sensors installed in the vehicle; and
selecting any one of the one or more candidate paths as an autonomous driving path based on the evaluation of the difficulty of driving in each section.

8. The method according to claim 7, wherein generating the one or more candidate paths is based on a time or a distance.

9. The method according to claim 7, wherein evaluating the difficulty of driving of one or more candidate paths in each section is based on driving environment recognition rates of the one or more sensors, traffic congestion, weather information, and autonomous driving failure probability information.

10. The method according to claim 7, wherein the driving environment recognition rates of the one or more sensors indicate reliability of a lane recognition, a vehicle and structure recognition, and location recognition by the one or more sensors.
